(19) United States
(12) Patent Application Publication
(10) Pub. No.: US 2008/0238820 A1
(43) Pub. Date: Oct. 2, 2008

(54) Motion picture image processing system and motion picture image processing method

(75) Inventors: Yoshi Enami, Rittou-shi (JP); Masahiro Kikuchi, Kouka-shi (JP); Tsutomu Mizuguchi, Rittou-shi (JP); Hiroyuki Sano, Konan-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: OTSUKA ELECTRONICS CO., LTD

(21) Appl. No.: 12/076,517

(22) Filed: Mar. 19, 2008

(30) Foreign Application Priority Data
Mar. 29, 2007 (JP) 2007-088857
Mar. 29, 2007 (JP) 2007-088858

(51) Int. Cl. G09G 3/20

(52) U.S. Cl. 345/55

(57) ABSTRACT

A motion picture moving on a display screen 21 of a display device 2 to be evaluated is captured a plurality of times by means of a galvano camera 3a. The captured data include locations of the moving picture in the moving direction on the display device 2 to be evaluated and data on luminance of the display device at the respective time points of the locations. Based on these data, a motion picture eye-tracking simulation is performed, where an integration along the eye tracking direction over an integral multiple of 1 frame time is performed to obtain a motion picture response curve of the display device 2 to be evaluated. Evaluations of motion picture characteristics and motion picture blur can be made based on the motion picture response curve.

### BACKGROUND OF THE INVENTION

1. Field of the Invention

The present invention relates to a system and a method for evaluating motion picture display performance of a hold type display device to be evaluated (also referred to as “target display device”) by obtaining motion picture response curves of the target display device based on the motion of an image displayed on the screen of the target display device.

2. Description of the Related Art

Evaluations of motion picture display performance have been conducted by measuring the motion of a motion picture displayed on the screen of a display device such as Liquid Crystal Display (LCD), Plasma Display Panel (PDP), or Electroluminescence (EL) display.

A conventional method of evaluating motion picture display performance is a process in which a motion picture is captured by a stationary camera a plurality of times, and the captured images are saved as time-series still images, then the saved time-series still images are time-integrated while being shifted synchronously with the moving velocity of the motion picture to obtain a synthesized image, and sharpness of an edge of the synthesized image is evaluated. In particular, the sharpness of the edge more degrades when the image holding time is longer as in the case of LCD. This degradation of sharpness of the edge is digitized as index values in the foregoing method (Japanese Unexamined Patent Publication No. 2001-204049).

In the foregoing method of evaluating motion picture display performance, a synthesized image needs to be generated by integrating time-series static images. However, since the time-series static images to be captured are two-dimensional images, the photosensitive plane of the stationary camera is two-dimensional accordingly, which increases the number of times and duration of scanning of the photosensitive plane. For this reason, a sufficient number of images cannot be captured during the motion of the motion picture, failing to improve accuracy of motion picture display performance evaluation.

In addition, because of the increased number of times and duration of scanning of the stationary camera, a sufficient number of images cannot be captured during the motion of the motion picture. As a result, accuracy of motion picture display performance evaluation cannot be improved.

### SUMMARY OF THE INVENTION

Therefore, it is an object of the present invention to provide a motion picture image processing system and a motion picture image processing method that enables capturing of an increased number of images of a motion picture displayed on the screen of a display device to be evaluated to obtain motion picture response curves of the display device to be evaluated.

A motion picture image processing system according to the present invention comprises: an image signal generator for feeding a motion picture signal to the display device to be evaluated; a camera for capturing the motion picture displayed on the display device to be evaluated; and a computation section for determining an eye-tracking direction based on data of the motion picture captured by the camera collected on the time series and integrating luminance of the captured motion picture along the eye-tracking direction over a duration of time corresponding to an integral multiple of 1 frame time, thereby obtaining a motion picture response curve of the display device to be evaluated in relation to pixel location of the camera.

The system for obtaining motion picture response curves of this structure is capable of measuring positional data of a motion picture that moves on the display screen of the display device to be evaluated by capturing motion picture images by means of a camera. The obtained data include locations of the motion picture in the motion picture moving direction on the display device to be evaluated and data of luminance of the display device at the respective times of the locations. Based on the data, a motion picture eye tracking simulation is performed, where integration along the eye tracking direction by an integral multiple of 1 frame time is performed to obtain a motion picture response curve. Evaluations of motion picture characteristics, motion picture blur and the like can be made based on this motion picture response curve.

The aforementioned camera may be a line camera that is secured with respect to the display device to be evaluated and capable of exposure-photographing a plurality of times at time intervals shorter than 1 frame time of the display device to be evaluated. Using a line camera for photographing makes it possible to measure the respective positional data of the motion picture moving on the display screen of the target display device at a high speed and almost simultaneously. Therefore, accurate measurement can be made at one attempt without time lag for each position. In particular, since fixed-point measurements are made without moving the line camera in this structure, the camera does not need to be provided with a motion picture pursuing mechanism. Measurements of motion picture characteristics can thus be made easily, and cost, wear and failure of the system can be reduced.

The motion picture image processing system may further include an elongated slit provided on the screen of the display device to be evaluated, and the foregoing camera may be a galvano camera that is situated with respect to the display device to be evaluated and capable of exposure-photographing a plurality of times in synchronization with the motion of the motion picture while moving the field of view in a direction different from the direction in which the slit extends. Since the system for obtaining motion picture response curves of this structure employs a galvano camera for photographing, it is capable of measuring at high speed locational data of the motion picture moving on the display screen of the display device to be evaluated. Therefore, accurate measurement can be made without time lag for each location.

A method of obtaining a motion picture response curve of an image display device according to the present invention is an invention of a method that is substantially equivalent to the foregoing invention of the system for obtaining a motion picture response curve.

A motion picture image processing system according to another aspect of the present invention comprises: an image signal generator for feeding a motion picture signal to the display device to be evaluated; a camera for capturing the motion picture displayed on the display device to be evaluated; and a computation section for determining a temporal transition of the motion picture displayed on the display device to be evaluated for each pixel of the camera based on data of the motion picture captured by the camera a plurality of times that are collected on the time series, thereby obtaining a motion picture response curve of the display device to be evaluated.

In the system for obtaining motion picture response curves of this structure, a high speed simulation is performed based on data captured by means of the camera with one pixel of the camera being fixed and a motion picture response curve with respect to time is obtained. Evaluations of motion picture characteristics and motion picture blur can be made based on the motion picture response curve.

The aforementioned camera may be a line camera that is secured with respect to the display device to be evaluated and capable of exposure-photographing a plurality of times at time intervals shorter than 1 frame time of the display device to be evaluated. Since measurements are made without moving the line camera, the camera does not need to be provided with a motion picture pursuing mechanism and it is possible to easily measure the motion picture characteristics at a high speed and almost simultaneously. Therefore, accurate measurement can be made at one attempt without time lag for each location. In addition, cost, wear and failure of the system can be reduced.

The system may further include an elongated slit provided on the screen of the display device to be evaluate, and the foregoing camera may be a galvano camera that is situated with respect to the display device to be evaluated and capable of exposure-photographing a plurality of times in synchronization with the motion of the motion picture while moving the field of view in a direction different from the direction in which the slit extends.

A method of obtaining a motion picture response curve of an image display device according to the present invention is an invention of a method that is substantially equivalent to the foregoing invention of the system for obtaining a motion picture response curve.

These and other advantages, features and effects of the present invention will be made apparent by the following description of embodiments with reference to the accompanying drawings.

### BRIEF DESCRIPTION OF THE DRAWINGS

FIG. 1 is a schematic diagram showing the configuration of a motion picture image processing system 1 using a line camera 3 for capturing an image on a display device 2 to be evaluated.

FIG. 2 is an optical path diagram showing a relationship between a display screen 21 of the display device 2 to be evaluated and the detection plane of the line camera 3.

FIG. 3 is a schematic diagram showing the configuration of a motion picture image processing system 1a using a galvano camera 3a for capturing an image on the display device 2 to be evaluated.

FIG. 4 is a side view showing the structure of the motion picture image processing system 1a.

FIGS. 5(a)-5(d) are diagrams showing a temporal transition of an image on a two-dimensional CCD array of the galvano camera 3a.

FIG. 6 is a graph showing luminance signals detected at the detection plane of the camera, where the horizontal axis represents pixel and the vertical axis represents time.

FIG. 7 is a photograph showing the graph in FIG. 6 displayed on the computer screen.

FIG. 8 is a graph showing temporal transitions of luminance signals of the respective colors, where each of the display pixels on the line camera 3 is observed separately.

FIG. 9 is a photograph showing the graph in FIG. 6 displayed on the computer screen.

FIGS. 10 (a), 10(b) illustrate a method for coordinate conversion to represent the eye tracking direction as one axis.

FIG. 11(a) is a photograph before coordinate conversion.

FIG. 11(b) is a photograph after coordinate conversion.

FIG. 12 is a graph where luminance signal G(x) is calculated taking 1 frame as the integration range and drawn as a motion picture response curve with the horizontal axis representing pixel.

### DETAILED DESCRIPTION OF PREFERRED EMBODIMENTS

### <System Structure 1>

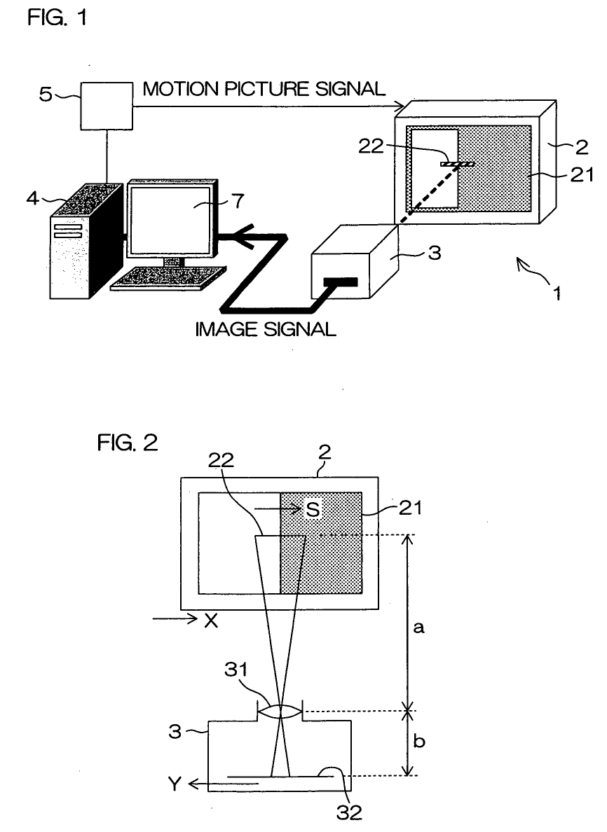

FIG. 1 is a schematic diagram showing the configuration of a motion picture image processing system 1 for evaluating the motion picture display performance of a display device 2 to be evaluated based on the motion of an image displayed on a display screen 21 of the display device 2 to be evaluated.

The motion picture image processing system 1 includes a line camera 3 for photographing the display screen 21 of the hold-type display device 2 to be evaluated, a computer control section 4 for obtaining motion picture response curves based on the images photographed by the line camera 3, and an image signal generator 5 for feeding image signal for displaying a motion picture to the display device 2 to be evaluated.

In the case of FIG. 1, a half-and-half (step-like) image with brightness of 100% (white) in the left half and brightness of 0% (black) in the right half is used as the “motion picture” displayed on the display device 2 to be evaluated. The central part at which the brightness is shifted is referred to as the “edge”. The motion picture is supposed to move from left to right on the display screen 21.

The line camera 3 is secured with respect to the display device 2 to be evaluated and has a lens 31 and a detection plane 32 comprising a one-dimensional CCD array that includes a plurality of photodiodes arranged in the horizontal direction. Meanwhile, the system may also be arranged such that a two-dimensional CCD array is used and data in the vertical direction are covered by means of a mask or the like so that only data in one horizontal line can be obtained.

The line camera 3 scans only one line during one exposure. The time for scanning one line is far shorter than the time for scanning one frame of the display device 2 to be evaluated. As a result, it takes only a very short time to readout. For example, while the time for scanning one frame of the display device 2 to be evaluated is 1/60 second, the time for scanning one line by the line camera 3 is several tens microseconds.

Image signals taken by the line camera 3 are input into the computer control section 4 via an image capture I/O board.

Meanwhile, a display control signal for selecting an image to be displayed is sent from the computer control section 4 to the image signal generator 5, and based on this display control signal, the image signal generator 5 feeds a motion picture image signal to the display device 2 to be evaluated so that an image is displayed as a motion picture moving at a predetermined speed. The function of the image signal generator 5 may be incorporated into the computer control section 4.

FIG. 2 is an optical path diagram showing a relationship between the display device 2 to be evaluated and the detection plane of the line camera 3.

Light rays from a one-dimensional field of view 22 of the line camera 3 on the display screen 21 come incident on the lens 31 of the line camera 3 to be detected on the detection plane 32 of the line camera 3.

Let the distance along the optical path between the display device 2 to be evaluated and the lens be represented by a, and the distance between the lens and the detection plane 32 be represented by b. When a focal length f of the lens is given, the relationship between a and b can be determined using the following equation:

1/f=1/a+1/b

Let the coordinate of the display screen 21 of the target display device 2 to be X, as shown in the drawing, and the coordinate of the detection plane 32 of the line camera 3 to be Y. When the magnification of the lens of the line camera 3 is represented by M,

Y=MX

is satisfied. Magnification M is expressed using the foregoing a, b as follows:

M=−b/a

### <System Structure 2>

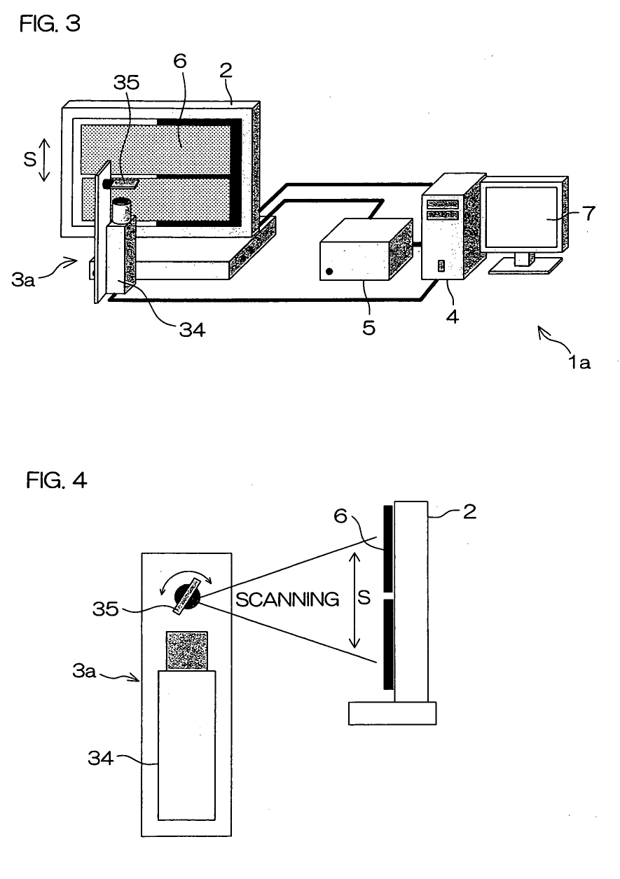

FIG. 3 is a schematic diagram illustrating the configuration of a motion picture image processing system 1a for evaluating motion picture display performance of a display device 2 to be evaluated based on the motion of an image displayed on the display screen 21 of the target display device 2. FIG. 4 is a side view showing a positional relationship between the display device 2 to be evaluated and a galvano camera 3a.

The motion picture image processing system 1a includes a galvano camera 3a for photographing the display screen 21 of the hold-type display device 2 to be evaluated, a computer control section 4 for obtaining motion picture response curves based on the images captured by the galvano camera 3a, and an image signal generator 5 for feeding a motion picture image signal for displaying a motion picture moving at a predetermined speed to the display device 2 to be evaluated.

In the case of FIG. 3, a half-and-half (step-like) image with brightness of 100% (white) in the left half and brightness of 0% (black) in the right half is used as the “motion picture” displayed on the display device 2 to be evaluated. The central part at which the brightness is shifted is referred to as the “edge”. The motion picture is assumed to move from left to right on the display screen 21. The display screen 21 of the display device 2 to be evaluated is covered with a mask 6 with a horizontal slit.

The galvano camera 3a is constituted of a camera body 34 that includes a two-dimensional CCD array including a plurality of photodiodes arranged vertically and horizontally and a galvano mirror 35. The camera body 34 has a field of view including a part or the whole of the display screen 21 of the display device 2 to be evaluated. The field of view has a rectangular shape.

The galvano mirror 35 is provided between the camera body 34 and the display device 2 to be evaluated and rotates about a horizontal axis. The galvano mirror 35 is constituted, for example, such that a permanent magnet is rotatably placed in a magnetic field generated by an electric current flowing in a coil, and a mirror is attached to the rotation shaft of the permanent magnet, which can rotate the mirror smoothly and rapidly.

In response to the rotation of this galvano mirror 35, the field of view of the camera can move on the display screen 21 in a direction S (up and down direction) perpendicular to the moving direction of the motion picture. In a duration of time in which the field view of the camera moves from down to up on the display screen 21, the edge of the motion picture moves from left to right on the display screen 21. That is, the duration of time in which the edge of the motion picture moves left to right is included in the duration of time in which the field of view of the camera moves from down to up on the display screen 21. The signal for driving the galvano mirror 35 to rotate is fed from the computer control section 4 via a galvano mirror drive controller. Instead of providing the galvano mirror 35 and the camera body 34 separately, a camera such as a light-weight digital camera or the like may be mounted on a rotary stage so that it is rotationally driven by a rotation drive motor.

The time for one exposure (shutter opening time) of the camera body 34 is equal to or longer than the time for scanning one frame of the display device 2 to be evaluated. The ratio between one exposure time of the camera body 34 and the time for scanning one frame of the display device 2 to be evaluated is represented by “n”. For example, while the time for scanning one frame of the display device 2 to be evaluated is 1/60 second, the exposure time of the camera body 34 is a time corresponding to n frames (n/60 second) of the display device 2 to be evaluated.

Here, “n” is preferably not less than 1, and more preferably not less than 3. This is because when “n” is not less than 1, image signals can be time-integrated on the two-dimensional CCD array over a duration of time substantially longer than the time for drawing one frame, so that isolated noise occurrence can be eliminated. The reason for stating “preferably not less than 3” is that when the exposure time is as long as 3 frames, it is possible to take the central one frame thoroughly into the two-dimensional CCD array while discarding the anterior and posterior frames in the case where the starting of exposure and the starting of the frame are not synchronous with each other. The upper limit of “n” may be determined such that the motion picture can be measured over a time during which the motion picture moves from one end to the other end of the screen, and it may be determined to be within that time. Since various values can be set for the moving speed of the motion picture, the upper limit thereof cannot be specified. However, no problem arises since it is usually within the maximum exposure time that can be set by the camera body 34.

Image signals obtained by the camera body 34 are taken into the computer control section 4 via an image capture I/O board.

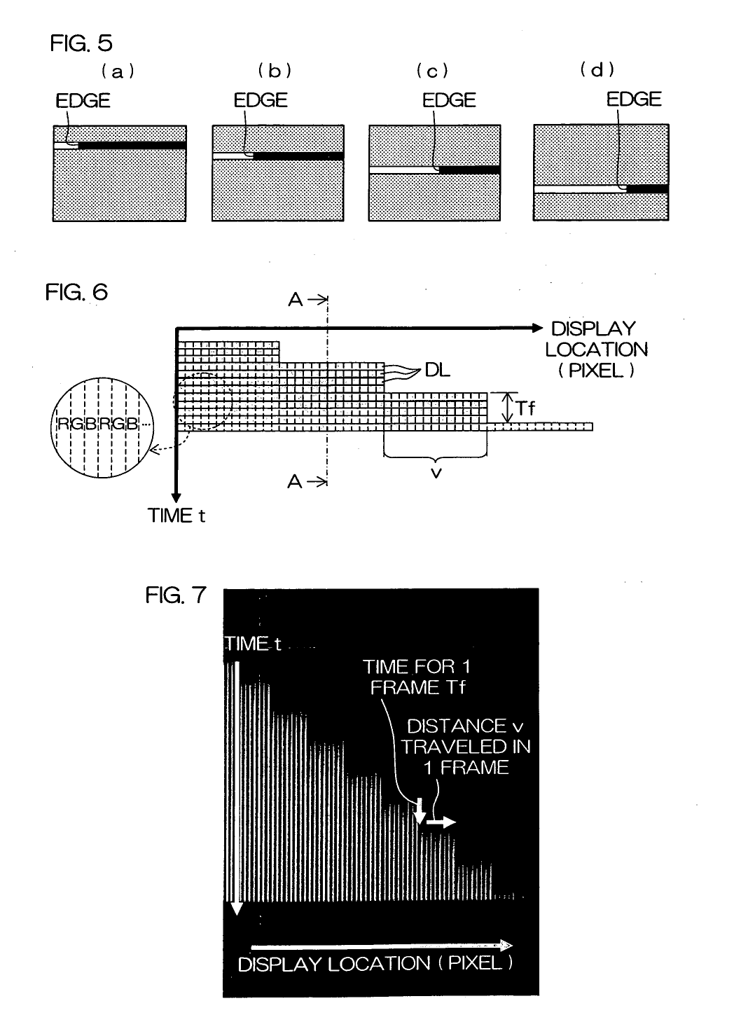

FIGS. 5(a)-5(d) show a temporal transition of an image that appears on the two-dimensional CCD array of the camera body 34.

While the galvano mirror 35 makes one rotation, the edge of the motion picture moves left to right. During this time, the camera body 34 performs exposure-photographing of the two-dimensional CCD array. Thus, image signals are accumulated in the two-dimensional CCD array. Since the display screen 21 of the display device 2 to be evaluated is covered with the mask 6 with the horizontal slit as mentioned above, motion picture images as shown in FIGS. 5(a)-5(d) are obtained through the slit. Motion picture images obtained on the two-dimensional CCD array form a configuration as horizontal lines accumulated on the time series.

### <Analysis Procedure>

The following analysis procedure is common to the motion picture image processing systems 1 and 1a.

The following analysis procedure is accomplished by the computer of the motion picture image processing system 1 or 1a executing a program stored in a predetermined medium such as CD-ROM or hard disk provided in the motion picture image processing system 1 or 1a.

A graph of luminance signal detected by the line camera 3 or galvano camera 3a with the horizontal axis representing pixel and vertical axis representing time is shown in FIG. 6, and a photograph taken when the graph is displayed on the screen of the computer is shown in FIG. 7.

In FIGS. 6, 7, “Tf” indicates time for scanning 1 frame of the display device 2 to be evaluated. The display device 2 to be evaluated is a hold-type display device, where the motion picture is kept still within one scanning time Tf. Distance traveled by the motion picture between adjacent frames is denoted by v. Within this scanning time Tf, the line camera 3 performs exposure a plurality of times (while 4 times of exposure are depicted in FIG. 6, actually it is about 100 times), or while the galvano mirror 35 makes one rotation, the galvano camera 3a performs exposure a plurality of times. The horizontal lines obtained from the respective exposures are denoted by DL. Each of the lines includes three pixel components including R (Red), G (Green), B (Black) arranged repeatedly as shown in the enlarged drawing in FIG. 6, and the detected signals constitute serial luminance signals including R, G, B alternately repeated, which can be converted into parallel signals by processing of the built-in control section (not shown) in the camera, and can be output separately as signal lines of R, G, B, respectively. In the foregoing manner, response curves of the respective pixels R, G, B of the display can be obtained by means of either monochrome line camera 3 or monochrome galvano camera 3a.

Then, in FIG. 6, one display pixel of the camera is fixed to obtain time-series luminance signal lines. This operation is the same, for example, as obtaining signals along the A-A section in FIG. 6.

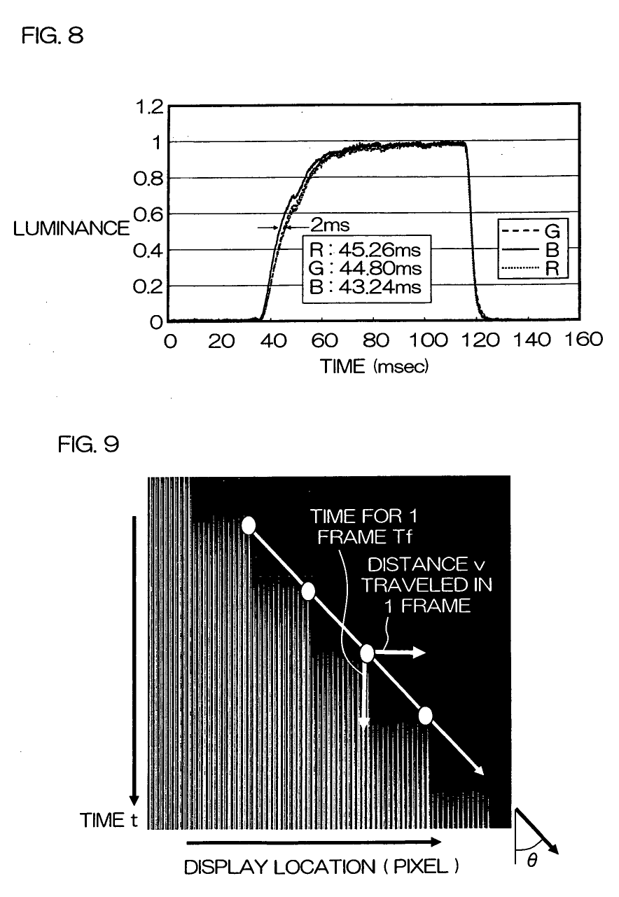

FIG. 8 is a graph showing temporal transitions of luminance signals, where the luminance signal of each color constituting the pixel is plotted temporally with one display pixel of the camera being fixed.

Response curves each drawn by focusing on one pixel of the camera can be obtained by this graph. Luminance of each color rises with time in response to the movement of the edge on the display screen 21 of the display device 2 to be evaluated, and based on the configuration of the rising part, the response time of each of R, G, B can be obtained. Here, the response time refers to time taken from the time when the luminance is 10% of the maximum graduation to the time when the luminance reaches 90% of the maximum graduation. In the case of FIG. 8, the measured values of response time of R, G and B pixels are 45.26 msec, 44.80 msec and 43.24 msec, respectively. Since there is a difference of about 2 msec between R pixel and B pixel, it is understandable that color unevenness may occur in the edge of the motion picture when the display screen 21 of the display device 2 to be evaluated is visually observed.

As described above, respective motion picture response curves of RGB pixels can be obtained by capturing temporal transition of the motion picture displayed on the display device 2 to be evaluated at one pixel of the camera.

Now, another procedure for obtaining motion picture response curves is described, which is different from the procedure for obtaining respective motion picture response curves of RGB pixels shown in FIG. 8, where the direction in which an eye pursues a motion picture (smooth pursuit eye tracking) is focused on.

FIG. 9 is a photograph (the same as that in FIG. 7) obtained when luminance signals detected by the camera are displayed on the screen 7 of the computer with the horizontal axis representing pixel and the vertical axis representing time. Here, white dots indicate the locations of the edge of the motion picture that appear during scanning of 1 frame.

It can be assumed that when a person sees a motion picture, his or her eyes are smoothly moving in the moving direction of the motion picture. That is, the eye-tracking direction can be assumed to be along the movement of the edge of the motion picture. This eye-tracking direction of a person is shown as the direction of a line connecting a series of the white dots in the temporal spatial space of FIG. 9. When this direction is represented by θ, the following equation is satisfied:

θ=tan⁻¹ (distance v traveled by motion picture in 1 frame)/(display time duration Tf in 1 frame of the display device)

Now, integration of 1 frame of display along this eye-tracking direction is attempted.

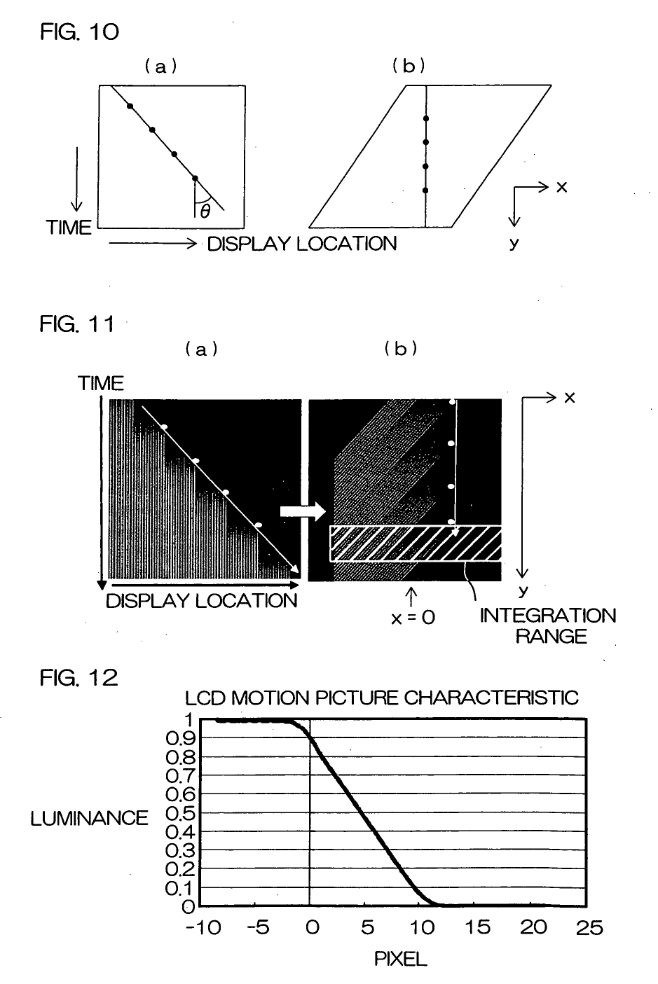

First, coordinate conversion is performed in order to take the eye-tracking direction as one axis. FIGS. 10(a) and 10(b) illustrate a method of coordinate conversion. FIG. 10(a) shows a rectangular coordinate system as that in FIG. 9 in which the horizontal axis represents display location of a line camera 3 and the vertical axis represents time. This is parallel-translated (in such a manner that the amount of displacement becomes greater as time goes back) so that the eye-tracking direction forms the vertical axis. FIG. 10 (b) shows the coordinate system after the coordinate conversion. The direction of the vertical axis in the coordinate system after conversion is represented by “y”, and the direction perpendicular to this is represented by “x”. The x direction is parallel to the direction of the “display location” axis before conversion. Luminance signal in this coordinate system after conversion is represented by G(x,y).

FIGS. 11(a), 11(b) show images before and after coordinate conversion of the image shown in FIG. 9. FIG. 11(a) is the image of the photograph before conversion, and FIG. 11(b) is the image of the photograph after conversion. The eye-tracking direction is along the y-axis. Since the x-axis is along the same direction as the “display location” axis before conversion, it can be converted into the number of pixels.

Now, luminance signal G(x,y) is integrated over a distance corresponding to an integral multiple of 1 frame. When the luminance signal G(x,y) after the integration is represented by G(x), the following relationship is satisfied:

G(x)=∫G(x,y)dy

The range of integration is an “integral multiple of 1 frame”, that is, from a white dot to another white dot in FIG. 11(b) FIG. 11(b) shows an integration range of “1 multiple of 1 frame” as an example.

The luminance signal G(x) determined by integration with an integration range of 1 frame is converted into the number of pixels to form the horizontal x-axis, thereby producing the graph in FIG. 12. This FIG. 12 represents a motion picture response curve. This motion picture response curve corresponds to what is observed by a human eye smoothly tracking the motion picture displayed on the display screen.

Based on the motion picture response curve in FIG. 12, motion picture response time, motion picture blur time, blur width and the like can be calculated.

With the x-axis representing the number of pixels of the display, blur width is calculated to be the number of pixels that is included in the range between 10% and 90% of the output curve. In the case of FIG. 12, the blur width is about 10 pixels.

Motion picture blur time is calculated by converting the x-axis in FIG. 12 into time axis using a multiplication of “(the number of pixels of display/the number of pixels traveled by motion picture frame)*1 frame time.” In this case, the motion picture blur time is determined to be the duration of time corresponding to the range between 10% and 90% of the output curve.

The present application corresponds to Japanese Patent Application No. 2007-088857 filed with Japanese Patent Office on Mar. 29, 2007 and Japanese Patent Application No. 2007-088858 filed with Japanese Patent Office on Mar. 29, 2007, and the whole disclosure thereof is incorporated herein by reference.

What is claimed is:

1. A motion picture image processing system for obtaining a motion picture response curve of a display device to be evaluated based on a motion of an image displayed on a screen of the display device to be evaluated, comprising:
an image signal generator for feeding a motion picture signal to the display device to be evaluated;
a camera for capturing a motion picture displayed on the display device to be evaluated; and
a computation section for determining an eye-tracking direction based on data of the motion picture captured by the camera collected on a time series and integrating luminance of the captured motion picture along the eye-tracking direction over a duration of time corresponding to an integral multiple of 1 frame time, thereby obtaining a motion picture response curve of the display device to be evaluated in relation to pixel location of the camera.

2. The motion picture image processing system according to claim 1, wherein the camera is a line camera that is secured with respect to the display device to be evaluated and capable of performing exposure-photographing a plurality of times at time interval shorter than 1 frame time of the display device to be evaluated.

3. The motion picture image processing system according to claim 1, further comprising an elongated slit provided on the screen of the display device to be evaluated,
wherein the camera is a galvano camera that is situated with respect to the display device to be evaluated and capable of exposure-photographing a plurality of times in synchronization with the motion of the motion picture while moving a field of view thereof in a direction different from a direction in which the slit extends.

4. The motion picture image processing system according to claim 1, wherein the eye-tracking direction is determined based on the time for 1 frame of the display device to be evaluated and a distance traveled by the motion picture image signal between adjacent frames.

5. The motion picture image processing system according to claim 1, wherein the computation section obtains a motion picture response curve separately for each color.

6. A method for obtaining a motion picture response curve based on a motion of an image displayed on a screen of a display device to be evaluated, comprising steps of:
displaying a motion picture on the display device to be evaluated;
capturing the displayed motion picture a plurality of times by a camera;
determining an eye-tracking direction based on data of the image captured by the camera that are collected on a time-series; and
integrating luminance of the captured image along the eye-tracking direction over a duration of time corresponding to an integral multiple of 1 frame time, thereby obtaining a motion picture response curve of the display device to be evaluated in relation to pixel location of the camera.

7. The method for obtaining a motion picture response curve according to claim 6, wherein the camera is a line camera that is secured with respect to the display device to be evaluated and capable of exposure-photographing a plurality of times at time interval shorter than 1 frame time of the display device to be evaluated, and
a plurality of times of exposure-photographing of the motion picture are performed by the line camera.

8. The method for obtaining a motion picture response curve according to claim 6, wherein an elongated slit is provided on the screen of the display device to be evaluated,
the camera is a galvano camera that is situated with respect to the display device to be evaluated and capable of exposure-photographing a plurality of times in synchronization with the motion of the motion picture while moving a field of view thereof in a direction different from a direction in which the slit extends, and
the galvano camera performs exposure-photographing of the motion picture a plurality of times in synchronization with the motion of the motion picture while moving the field of view in the direction different from the direction in which the slit extends.

9. The method for obtaining a motion picture response curve according to claim 6, wherein a motion picture response curve is obtained separately for each color. (Hereinafter, the second invention)

10. A motion picture image processing system for obtaining a motion picture response curve of a display device to be evaluated based on a motion of an image displayed on a display device to be evaluated, which comprises:
an image signal generator for feeding a motion picture signal to the display device to be evaluated;
a camera for capturing a motion picture displayed on the display device to be evaluated; and
a computation section for determining a temporal transition of the motion picture displayed on the display device to be evaluated for each pixel of the camera based on data of the motion picture captured by the camera a plurality of times that are collected on a time series, thereby obtaining a motion picture response curve of the display device to be evaluated.

11. The motion picture image processing system according to claim 10, wherein the camera is a line camera that is secured with respect to the display device to be evaluated and capable of exposure-photographing a plurality of times at time interval shorter than 1 frame time of the display device to be evaluated.

12. The motion picture image processing system according to claim 10, further comprising an elongated slit provided on the screen of the display device to be evaluated,
wherein the camera is a galvano camera that is situated with respect to the display device to be evaluated and capable of exposure-photographing a plurality of times in synchronization with the motion of the motion picture while moving a field of view thereof in a direction different from a direction in which the slit extends.

13. The motion picture image processing system according to claim 10, wherein the computation section obtains a motion picture response curve separately for each color.

14. A method for obtaining a motion picture response curve of a display device to be evaluated based on a motion of an image displayed on the display device to be evaluated, comprising steps of:
displaying a motion picture on the display device to be evaluated;
capturing the displayed motion picture a plurality of times by a camera; and
determining a temporal transition of the motion picture displayed on the display device to be evaluated for each pixel of the camera based on data of the motion picture captured by the camera a plurality of times that are collected on a time series, thereby obtaining a motion picture response curve of the display device to be evaluated.

15. The method for obtaining a motion picture response curve according to claim 14, wherein the camera is a line camera that is secured with respect to the display device to be evaluated and capable of exposure-photographing a plurality of times at time interval shorter than 1 frame time of the display device to be evaluated.

16. The method for obtaining a motion picture response curve according to claim 14, wherein an elongated slit provided on the screen of the display device to be evaluated is used,
the camera is a galvano camera that is situated with respect to the display device to be evaluated and capable of exposure-photographing a plurality of times in synchronization with the motion of the motion picture while moving a field of view thereof in a direction different from a direction in which the slit extends,
and the galvano camera performs exposure-photographing of the motion picture a plurality of times in synchronization with the motion of the motion picture while moving the field of view in the direction different from a direction in which the slit extends.

17. The method for obtaining a motion picture response curve of a display device according to claim 14, wherein a motion picture response curve is obtained separately for each color.
